(19) United States
(12) Patent Application Publication
(10) Pub. No.: US 2015/0362126 A1
(43) Pub. Date: Dec. 17, 2015

(54) FLAT WALLED LIQUID MOBILE TANK WITH BRAKE LINES

(71) Applicant: Meridian Manufacturing, Inc., Storm Lake, IA (US)

(72) Inventors: Christopher T. Fitzgerald, Pomeroy, IA (US); Sam J. Plett, Winkler (CA); Mark A. Loewen, East St. Paul (CA)

(21) Appl. No.: 14/306,371

(22) Filed: Jun. 17, 2014

(51) Int. Cl. F17C 1/08

(52) U.S. Cl. CPC F17C 1/08; F17C 2203/012; F17C 2260/011

(57) ABSTRACT

A bulk liquid mobile tank is provided for above ground and transportation use. The tank has flat walls with corner welds. The side walls and end walls of the tank each have at least one horizontal brake line extending horizontally to minimize deflection of the walls, reduce the bending moments, and control stress propagation through the welds. The brake lines are V-shaped.

### BACKGROUND OF THE INVENTION

In Canada, mobile liquid fuel tanks or trailers which are transported over the road must meet several tests prior to use. These tests include:
1. a static leak test wherein the tank is filled with fluid and checked for leaks;
2. a hydrostatic pressure test, wherein the tank is filled with water until the internal pressure reaches 9.4 psig (65 KPa) and held for 10 minutes, followed by a second pressure point where the internal pressure reaches 29 psig (200 KPa) and hold for 10 minutes;
3. a drop test, wherein the water-filled tank is lifted 1.2 meters and dropped;
4. a rollover test, wherein the filled tank is rotated on a special skid until it rolls over onto its top; and
5. a vibration test wherein the tank is subjected to vibrations.

Each of these tests must be passed without loss of liquid from the tank. Normally, the most difficult test to pass is the pressure test. Tanks with flat panels or walls can have forces approaching 200,000 pounds on each wall of the tank. This pressure can cause extreme stress in all the components and weldments, and cause deformation. Tank structure, geometry and weldments must be designed to transfer the bending stresses away from the perimeter weld seams and convert the bending stresses to tensile stresses within the welds. These pressures and stresses make a square-cornered tank a pressure vessel, which are normally designed with a cylindrical shape to account for the high stress loads. Thus, to pass the test requirements, the square tanks typically have an extremely over-designed material gauge. For example, prior art, flat sided and square-cornered tanks typically use thick, heavy gauge steel, for example, 0.25 inch thick, to withstand the high stresses. Such thick steel is costlier and more difficult to manufacture, and the heavier weight of the thick steel requires stronger, heavier towing vehicles.

Underground or buried tanks are known to use profile changes, such as corrugations, to increase tank strength. However, in-ground tanks also benefit from support by the surrounding earth to help contain and control the internal pressures and stresses within the underground tank. Thus, the pressure effects on underground tanks are considerably different than the pressure effects on above ground liquid mobile tanks.

Cylindrical tanks have substantially different strength characteristics compared to flat-walled or square-cornered tanks. Mobile tanks also are subjected to different forces than stationary tanks, such as vibrations during transportation, and movement of liquid within the tanks during transport, such as during stopping, starting and turning.

Accordingly, a primary objective of the present invention is the provision of an improved liquid mobile tank having flat walls.

Another objective of the present invention is the provision of a liquid mobile tank having flat walls and square corners which passes all the Canadian fuel trailer requirements and tests for over-the-road transportation.

Yet another objective of the present invention is the provision of a flat walled liquid mobile tank which can withstand high pressures and bending stresses without deformation when filled with liquid.

A further objective of the present invention is the provision of a liquid mobile tank which is easy and economical to manufacture, and safe and durable in use, without being over-designed.

These and other objectives will become apparent from the following description of the invention.

### SUMMARY OF THE INVENTION

The liquid mobile tank of the present invention has opposite flat side walls, opposite flat end walls, a flat bottom wall, and a flat top wall. A horizontal brake line is formed in each of the side walls and end walls and extends continuously around the tank. The top wall also includes one or more brake lines. A pair of angle irons are welded to the bottom wall of the tank. The brake lines increase the strength of the walls and reduce stress propagation through the corner welds.

### BRIEF DESCRIPTION OF THE DRAWINGS

FIG. 1 is a perspective view of the liquid mobile tank design according to the present invention.

FIG. 2 is a top plan view of the tank.

FIG. 3 is an elevation view from one side of the tank.

FIG. 4 is an elevation view from the opposite side of the tank.

FIG. 5 is an elevation view from one end of the tank.

FIG. 6 is an elevation view from the opposite end of the tank.

FIG. 7 is a plan view of the bottom of the tank.

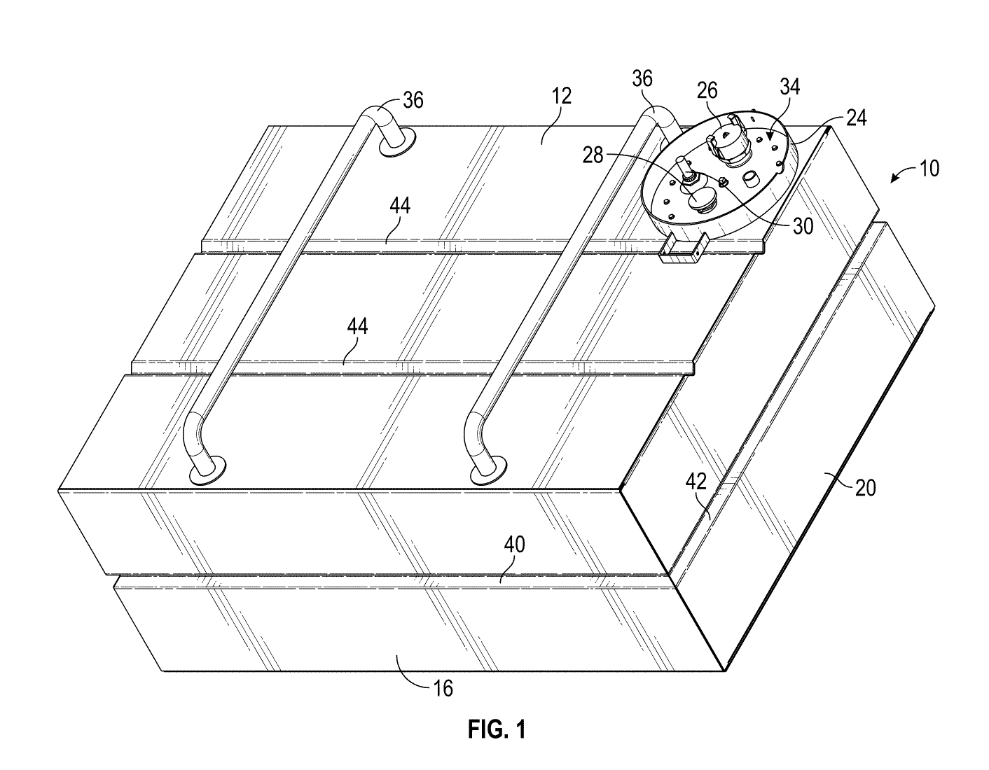

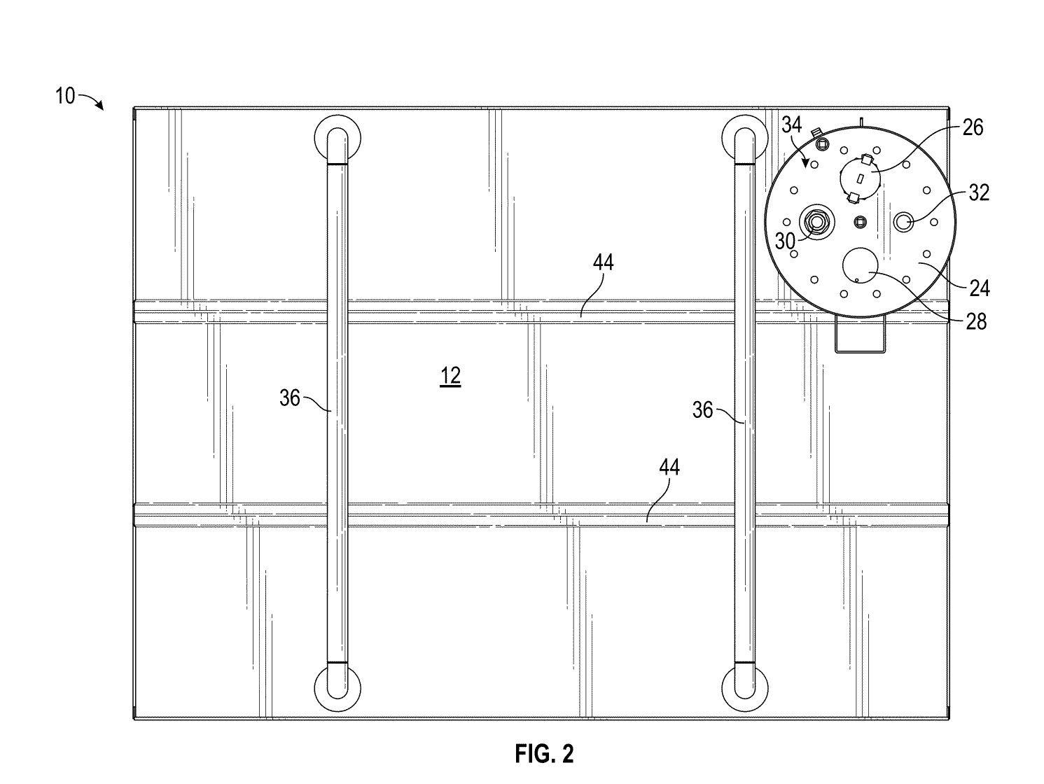

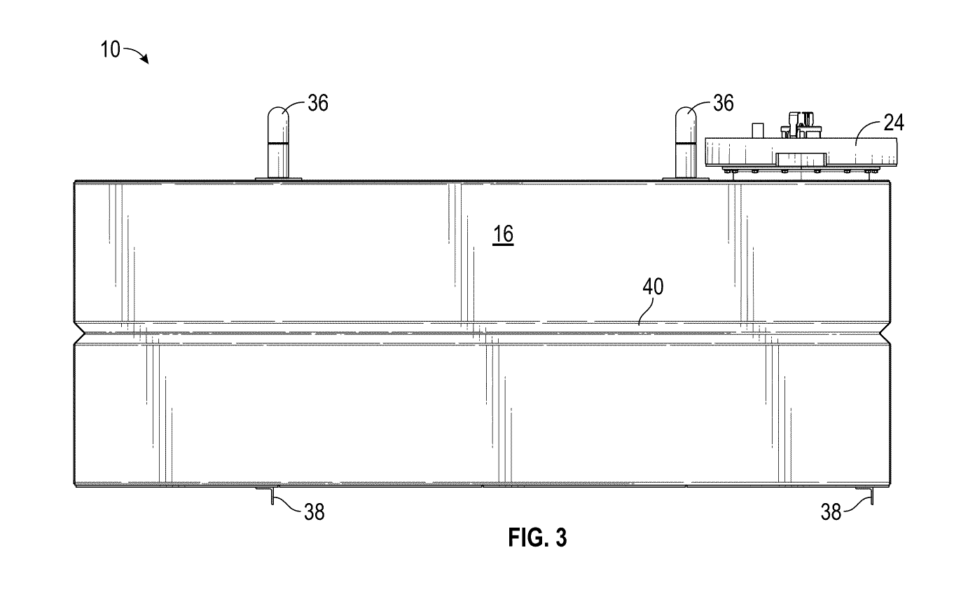

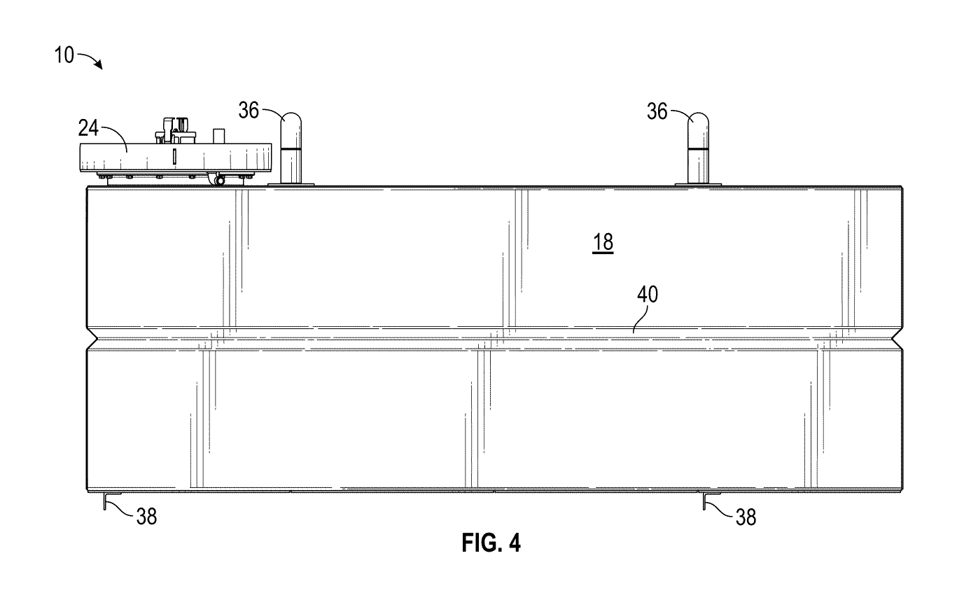

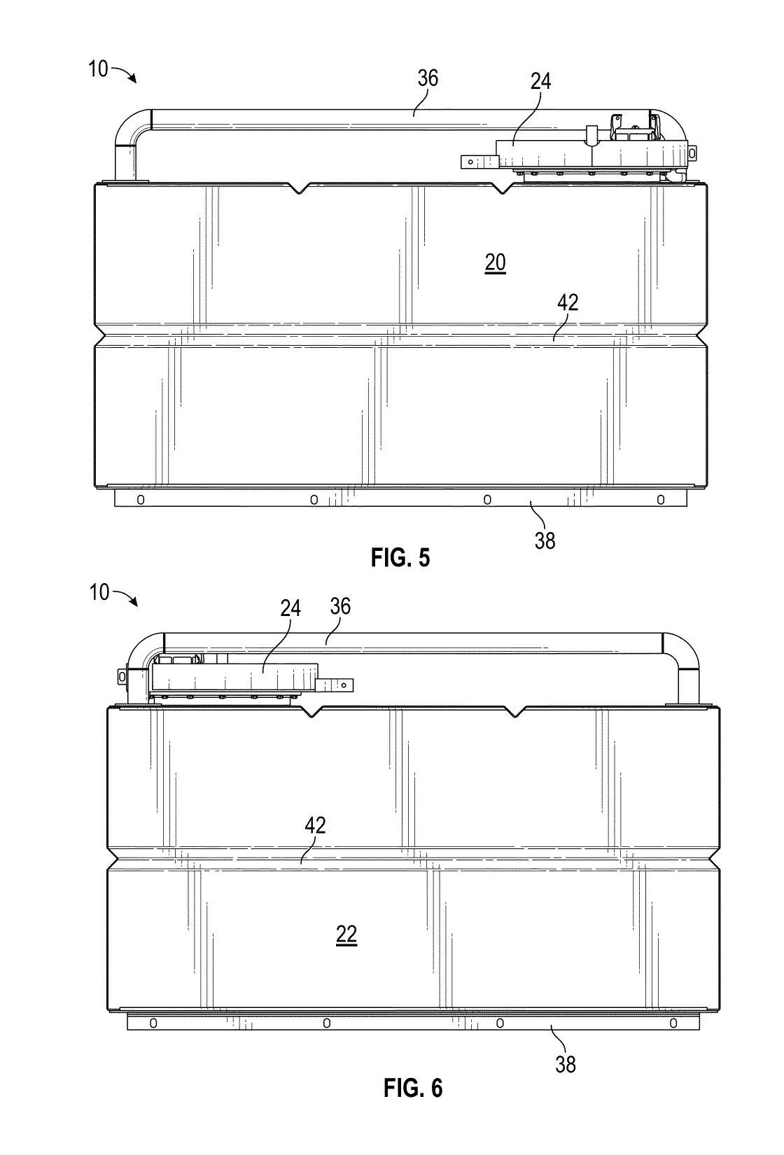

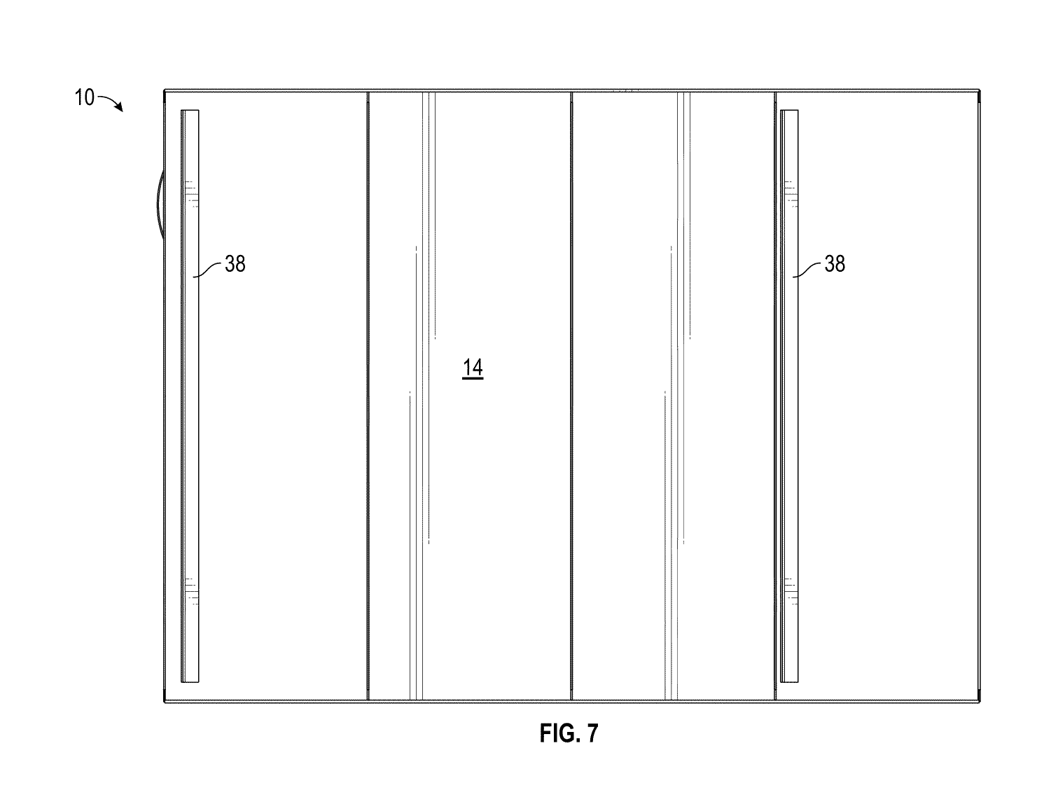

### DETAILED DESCRIPTION OF THE PREFERRED EMBODIMENTS

The liquid mobile tank of the present invention is generally designated by the reference numeral 10 in the drawings. The tank 10 includes a top wall 12, a bottom wall 14, opposite side walls 16, 18, and opposite end walls 20, 22. The top wall 12 of the tank 10 includes a manhole with a cover or lid 24 which can be opened to allow access inside the tank 10. The cover 24 also includes a fill opening and drain or discharge opening covered by removable caps 26, 28, a level 30, a vent opening 32, and an anti-spill cavity or base 34 to collect a spillage of liquid when filling or draining the tank 10. One or more bars 36 may be welded or otherwise secured to the top wall 12 of the tank 10 for rollover protection. A pair of angle irons 38 are welded or otherwise fixed to the bottom wall 14 of the tank 10 and spaced apart from one another. The angle irons 38 provide structural support for the bottom wall 14.

The walls 12, 14, 16, 18, 20, and 22 are flat, with the perimeter edges being bent or welded to form square corners. A brake line 40 is formed in the opposite side walls 16, 18. A similar brake line 42 is also formed in the opposite end walls 20, 22. The brake lines 40, 42 extend horizontally, and preferably are located approximately midway between the top wall 12 and bottom wall 14. The brake lines 40, 42 mate with one another so as to form a continuous line around the tank 10. One or more similar brake lines 44 are also provided in the top wall 12. Preferably, the brake lines 44 extend parallel to the major axis of the top wall 12, though it is understood that the brake lines 44 could also extend parallel to the minor axis of the top wall 12. Preferably, the brake lines 40, 42 and 44 are V-shaped in cross-section, though other shapes may also be utilized.

The bottom wall 14 of the tank 10 includes conventional internal baffles to minimize fluid movement in the tank 10 during transport. Structural supports, such as angle irons, are welded to the inside of the bottom wall to add strength. The bottom wall 14 may be manufactured with thicker steel than the side walls 16, 18 the end walls 20, 22, and the top wall 12. For example, the bottom wall 14 preferably is made of ¼″ steel, while the remaining walls are 10 gauge steel.

The brake lines 40, 42, 44 function to control stress propagation and counteract the bending moments induced by the internal pressure within the tank 10, such that the corner welds are subjected to lower stresses, as compared to prior art square tanks. By counteracting the bending stresses, the tank walls have less deflection, thereby reducing the bending moment and stress propagation through the welds at the tank corners. Therefore, lighter gauge steel can be used so that the tank 10 still meets all structural, weight, cost, and manufacturability criteria.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An improved liquid mobile tank having flat side walls with corner welds, the improvement comprising:
a horizontal brake line in the side walls to reduce stress propagation through the welds.

2. The improved liquid mobile tank of claim 1 wherein the brake line is V-shaped.

3. The improved liquid mobile tank of claim 1 wherein the brake line extends along all the side walls.

4. The improved liquid mobile tank of claim 1 wherein the brake line extends continuously around the tank.

5. The improved liquid mobile tank of claim 1 wherein the tank includes a flat top wall with a brake line therein.

6. The improved liquid mobile tank of claim 5 wherein the top wall has a major axis and a minor axis, and the brake line is parallel to the major axis.

7. The improved liquid mobile tank of claim 1 wherein each side wall has upper and lower edges, and the brake line resides approximately midway between the upper and lower edges.

8. The improved liquid mobile tank of claim 1 wherein the tank includes a bottom wall with a pair of spaced apart angle irons attached thereto.

9. The improved liquid mobile tank of claim 8 wherein the bottom wall has a major axis and a minor axis, and the angle irons are parallel to the minor axis.

10. A bulk liquid mobile tank, comprising:
opposite flat side walls;
opposite flat end walls;
a flat bottom wall;
a flat top wall; and
a horizontal brake line formed in each side wall.

11. The bulk liquid mobile tank of claim 10 further comprising a horizontal brake line formed in each end wall.

12. The bulk liquid mobile tank of claim 11 wherein the brake lines in the side walls and end walls extend across the width of each wall.

13. The bulk liquid mobile tank of claim 10 further comprising at least one brake line in the top wall.

14. The bulk liquid mobile tank of claim 10 wherein the brake line in the side walls are approximately midway between the top wall and bottom wall.

15. The bulk liquid mobile tank of claim 10 wherein the top wall has a major axis and a minor axis, and the brake line is parallel to the major axis.

16. The bulk liquid mobile tank of claim 10 further comprising a pair of spaced apart angle irons attached to the bottom wall.

17. The bulk liquid mobile tank of claim 16 wherein the bottom wall has a major axis and a minor axis, and the angle irons are parallel to the minor axis.

18. The bulk liquid mobile tank of claim 10 wherein the brake line is V-shaped.

19. The bulk liquid mobile tank of claim 10 wherein adjacent walls form square corners.

20. The bulk liquid mobile tank of claim 19 wherein at least some of the corners are welded.
